(19) United States
(12) Patent Application Publication
(10) Pub. No.: US 2009/0047460 A1
(43) Pub. Date: Feb. 19, 2009

(54) ADHESIVE DISPENSING PRODUCT

(75) Inventors: Hans Lyhr, Assens (DK); Lasse Haahr Andersen, Tommerup (DK); Mads Sandahl Christensen, Tommerup (DK); Per Herholdt Madsen, Broby (DK); Peter Astrup Simmelsgaard, Vissenbjerg (DK)

Correspondence Address: SUGHRUE MION, PLLC, 2100 PENNSYLVANIA AVENUE, N.W., SUITE 800, WASHINGTON, DC, 20037, US

(73) Assignee: 3L-LUDVIGSEN A/S, TOMMERUP (DK)

(21) Appl. No.: 11/838,623

(22) Filed: Aug. 14, 2007

(51) Int. Cl. B32B 33/00

(52) U.S. Cl. 428/42.3

(57) ABSTRACT

The adhesive dispensing product comprises a coherent piece of carrier sheet material with two opposite surfaces, one of which is a first release surface, the piece of carrier sheet material has two opposite lateral side edges. A plurality of individual adhesive segments are present on the first release surface, which adhesive segments each has a circumferential surface, and the circumferential surfaces of adjacent adhesive segments are separated by a distance of at least 0.5 mm. The adhesive segments feature a first adhesiveness relative to the first release surface allowing the adhesive segments to be dispensed from the first release surface. The adhesive dispensing product further comprises a plurality of individual pieces of cover sheet material, which cover sheet material has two opposite surfaces, one of which is a second release surface. The adhesive segments feature a second adhesiveness relative to the second release surface allowing the adhesive segments to be dispensed from the second release surface. Each of the pieces of cover sheet material covers a number of said adhesive segments. The second release surface of the pieces of cover sheet material comprise a margin extending beyond at least a part of the circumferential surface of the respective adhesive segments.

### BACKGROUND OF THE INVENTION

The present invention relates to an adhesive dispensing product for dispensing segments of pressure sensitive adhesive to a substrate to be adhered to a surface, e.g. for dispensing a segment of pressure sensitive adhesive to a photograph to be adhered to a page in a photo album, for scrap booking purposes, etc.

A number of such adhesive dispensing products are known.

U.S. Pat. No. 6,640,864 discloses a carrier strip having opposite release surfaces and carrying on a first of said release surfaces a row of non-contiguous pressure sensitive adhesive segments, especially hot-melt adhesive segments. Further a cardboard box is disclosed housing a roll of said carrier strip for successively feeding out the carrier strip to present the adhesive segments one by one over an anvil surface for dispensing adhesive segments to a substrate. Using this cardboard box either the entire box with its anvil surface must be pressed against a substrate for dispensing an adhesive segment or the substrate must be held over and pressed against the anvil surface. In both cases it may be difficult to watch the dispensing. In one embodiment the carrier strip is perforated between adjacent adhesive segments for separation of pieces of carrier strip with an adhesive segment. In another embodiment adhesive segments are arrayed on a card of carrier material.

US-A-2005/0084641 discloses a carrier sheet carrying on a release surface an array of pressure sensitive adhesive segments and a cover sheet congruent with the carrier sheet is overlying the adhesive segments with a release surface facing the adhesive segments. The release surface of the cover sheet has a smaller tenacity or adhesiveness relative to the adhesive segments than the carrier sheet. The carrier sheet and the cover sheet have crisscross congruent perforations between adjacent adhesive segments for separation of larger or smaller parts of the sandwich comprising the carrier sheet, the adhesive segments and the cover sheet. The carrier sheet and possibly also the cover sheet may be transparent for enabling the adhesive segments to be visible through the respective sheets.

GB-A-2 019 807 discloses a strip of carrier material carrying a row of adhesive segments covered by a release strip.

Further several commercial products are known, i.a.:

“Craft Adhesive Double Stick Clear Dots” manufactured by 3M under the trademark “Scotch”, said product comprising a carrier sheet with an array of circular adhesive dots each covered by a congruent piece of cover sheet, the carrier sheet, the adhesive dots and the cover sheet being all transparent or clear. The congruence between the pieces of cover sheet and the adhesive segments makes it impossible to pick up an adhesive segment without getting in contact with the adhesive which in turn makes it difficult to dispense an adhesive segment correctly.

“Mounting Squares” manufactured by 3L under the trademark “Scrapbook Adhesives”, comprises a strip of carrier material with a transversal width, a strip of two-sides adhesive tape cut into adjacent closely spaced squares having the same transversal width as the carrier tape, and pieces of cover sheeting being congruent on three sides with the adhesive tape squares. The adhesive of the adjacent tape squares connect the adjacent tape squares along the length of their opposing sides. The pieces of cover sheeting extend on a fourth side beyond the adhesive tape squares and a transversal side of the carrier strip to provide for grapping a piece of cover sheeting. Thereby a piece of cover sheeting may be removed together with a square of tape from the carrier strip. Subsequently to dispensing the square of tape to a substrate the piece of cover sheeting may be removed from the square of tape. A roll of carrier strip with tape and cover sheeting is provided in a cardboard box, from which the carrier strip is pulled through a slot and along an outer surface of the box, whereby squares of tape appears one by one through the slot and being simultaneously released from the carrier strip, ready for dispensing. Due to the congruence on three sides between the pieces of cover sheeting and the squares of tape there is a risk of the user getting in contact with the adhesive during dispensing which may make correct dispensing difficult.

### BRIEF SUMMARY OF THE INVENTION

It is an object of the invention to provide an adhesive dispensing product comprising, a coherent piece of carrier sheet material with two opposite surfaces, one of which is a first release surface, said piece of carrier sheet material having two opposite lateral side edges, a plurality of individual adhesive segments present on said first release surface, said adhesive segments each having a circumferential surface, the circumferential surfaces of adjacent adhesive segments being separated by a distance of at least 0.5 mm, said adhesive segments featuring a first adhesiveness relative to said first release surface allowing the adhesive segments to be dispensed from said first release surface, a plurality of individual pieces of cover sheet material, a number of which are preferably confined within said lateral side edges of the piece of carrier sheet, said cover sheet material having two opposite surfaces, one of which is a second release surface, said adhesive segments featuring a second adhesiveness relative to said second release surface allowing the adhesive segments to be dispensed from said second release surface, each of said pieces of cover sheet material covering a part of said adhesive segments, said second release surface of said pieces of cover sheet material comprising a margin extending beyond at least part of the circumferential surface of the respective adhesive segments.

The adhesive segments are pressure sensitive or self-adhesive, i.e. they will adhere to a substrate upon being pressed against it.

The distance between adjacent circumferential surfaces of adjacent adhesive segments should be measured with the carrier sheet material in a plane state, because said distance will vary when the carrier sheet material is bent.

The distance between the circumferential surfaces of adjacent adhesive segments is preferably at least 1 mm and more preferably at least 2 mm.

By providing a piece of carrier sheet with a plurality of adhesive segments and a plurality of individual pieces of cover sheet material or cover sheeting it is obtained that one or a limited number of adhesive segments may easily be removed from the carrier sheet together with a piece of cover sheeting, the adhesive segment(s) being thereby uncovered to be dispensed while the piece of carrier sheet remains whole, thereby facilitating the handling of the adhesive dispensing product by the user.

I order to facilitate removing the adhesive segments together with the cover sheeting the second adhesiveness is preferably not less than the first adhesiveness and in many embodiments the second adhesiveness is preferably greater than the first adhesiveness.

In one embodiment two pieces of cover sheet material of any pair of adjacent pieces of cover sheet material are connected by a number of narrow fragile bridges of material, said number being less than four. In another embodiment adjacent individual adhesive segments are connected by a narrow fragile bridge of adhesive. Such narrow fragile bridges of connecting material will facilitate handling the cover sheet material during manufacturing, without providing a strong connection between adjacent pieces of cover sheeting or adhesive segments that would require an effort from the user to release one piece of cover sheeting from its neighboring pieces.

It should be noted that as used herein adhesiveness, which is also referred to in the art as stickiness or tack, is to be understood as a property of the interaction between an adhesive segment and a surface with which it is in contact.

The number of adhesive segments covered by an individual piece of cover sheeting is preferably one, two or four. Thus four adhesive segments on an individual piece of cover sheeting will correspond to the number of corners of a square substrate e.g. a photo. Providing too large a number of adhesive segments on an individual piece of cover sheeting will make the handling of that individual piece difficult.

The adhesive may comprise an internal carrier, such as sheeting of paper, plastics or foam material, covered by adhesive, but the adhesive segments are preferably a solid or clean adhesive, i.e. an adhesive without an internal tape of paper or other sheeting. Especially the adhesive may be a hot-melt adhesive or thermoplastic adhesive. The adhesive may be e.g. acrylics, especially 2-ethyl-hexylacrylate or butylacrylate; rubber such as SBR (Styrene-Butadiene Rubber), SBS Polystyrene-Polybutadiene-Polystyrene block copolymer) and SIS (Polystyrene-Polyisoprene-Polystyrene block copolymer); and EVA (Ethylene-vinyl acetate copolymer).

The pieces of cover sheeting are preferably confined within the lateral side edges of the piece of carrier sheet, thus facilitating the handling of the adhesive dispensing product, when no flaps are extending beyond the edges of the piece of carrier sheet.

The coherent piece of carrier material is in one embodiment a strip carrying a row of adhesive segments.

In another embodiment the coherent piece of carrier material is a card carrying an array of adhesive segments. In the latter embodiment the second adhesiveness is preferably greater than the first adhesiveness to facilitate the release of adhesive segments from the carrier sheeting together with a piece of cover sheeting.

In one embodiment the second adhesiveness is generally greater than the first adhesiveness to facilitate the release of adhesive segments from the carrier sheeting together a piece of cover sheeting.

In one embodiment the cover sheet material is translucent or transparent. This allows for watching the adhesive segment during dispensing or transferring it to a substrate.

Preferably the margins of the second release surface of the pieces of cover sheet material are surrounding the adhesive segments. This feature facilitates the handling a piece of cover sheeting while dispensing an adhesive segment without the user getting in contact with the adhesive.

Preferably a second surface of the carrier sheet material and/or a second surface of the cover sheet material is a non-release surface. This provides for wrapping up an erroneously dispensed adhesive segment in a spend piece of carrier sheet material or cover sheet material, to effectively assure that the adhesive segment is kept from sticking in unwanted places. Further, when coiling a carrier strip, the coil will due to internal friction not be inclined to uncoil, when the second surface of the cover sheet material is a non-release surface.

According to another aspect of the invention an adhesive dispensing product comprises, a box containing, a coiled coherent strip of carrier sheet material with two opposite surfaces, one of which is a first release surface, said piece of carrier sheet material having two opposite lateral side edges, a row of a plurality of individual adhesive segments present on said first release surface, said adhesive segments each having a circumferential surface, the circumferential surfaces of adjacent adhesive segments being separated by a distance, said adhesive segments featuring a first adhesiveness relative to said first release surface allowing the adhesive segments to be dispensed from said first release surface, a plurality of individual pieces of cover sheet material, said cover sheet material having two opposite surfaces, one of which is a second release surface, said adhesive segments featuring a second adhesiveness relative to said second release surface allowing the adhesive segments to be dispensed from said second release surface, each of said pieces of cover sheet material covering a number of said adhesive segments, said second release surface of said pieces of cover sheet material comprising a margin extending beyond at least a part of the circumferential surface of the respective adhesive segments, said box comprising a slot for exiting an uncoiled end of said strip, an outer surface adjacent said slot and a guide for guiding said uncoiled end along said outer surface, the uncoiled end of the strip there by following a path, said path making a sharp bend through said slot. This dispensing product will provide for dispensing pieces of cover sheeting with adhesive segments by pulling a free uncoiled end of the carrier strip. Due to the carrier strip's passage of a sharp bend the, when being forwarded, the adhesive segments may be released together with their pieces of cover sheeting at that bend, even if the second adhesiveness is equal to or slightly larger than the first adhesiveness.

### BRIEF DESCRIPTION OF THE SEVERAL VIEWS OF THE DRAWING

Examples of the invention will now be explained below with reference to the very schematic drawings, in which

FIG. 1 is a plan view of an adhesive dispensing product according to the invention,

FIG. 2 is a side view of the product shown in FIG. 2,

FIG. 3 is a plan view similar to FIG. 1 of second embodiment,

FIG. 4 is a perspective view illustrating a third embodiment,

FIG. 5 is a perspective view of a forth embodiment,

FIG. 6 shows a variant of the embodiment shown in FIG. 1,

FIG. 7 shows a variant of the embodiment shown in FIG. 4, and

FIG. 8 shows a strip detached from the embodiment shown in FIG. 7.

### DETAILED DESCRIPTION OF THE INVENTION

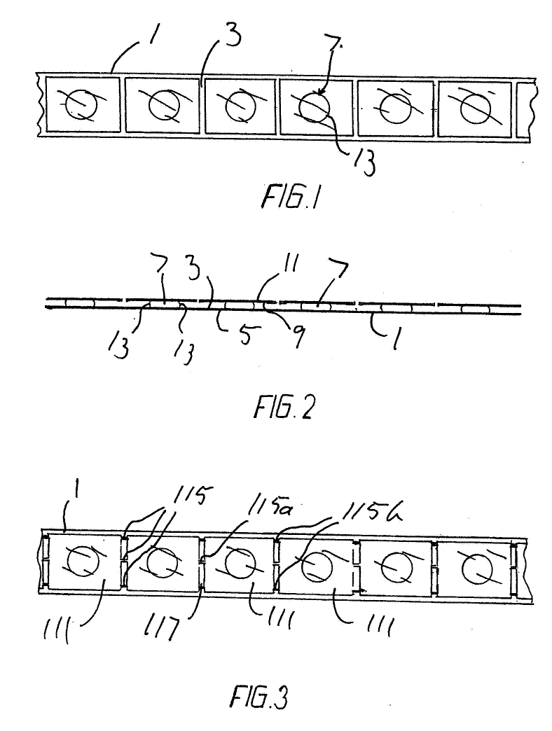

Referring to FIGS. 1 and 2 an adhesive dispensing product is shown comprising as a coherent piece of carrier material a carrier strip 1. The carrier strip 1 has a first carrier release surface 3 coated with a release agent, whereas a second carrier non-release surface 5 opposite to the first surface 3 is not coated to be slippery and/or have a low adhesiveness relative to the adhesive segments. On the first surface 3 adhesive segments 7 of adhesive is placed equidistantly in a row. The adhesive segments 7 has two opposite surfaces contacting respectively the first surface 3 and a third liner release surface 9 of a liner 11 comprising an individual piece of cover material. The third surface 9 is like the first surface 3 coated with a release agent. The liner 11 is transparent.

The liner 11 and especially its release surface 9 has a margin all around the adhesive segment 7 allowing a user to seize the liner 11 without getting in contact with the adhesive segment 7.

The individual adhesive segments 7 each have a circumferential surface 13 connecting the two opposite surfaces of the adhesive segments 7. The circumferential surfaces of adjacent adhesive segments are spaced apart to provide for the individuality of the adhesive segments.

The spacing of adjacent adhesive segments i.e. the spacing of their respective circumferential surfaces is at least 0.2 mm, preferably at least 0.5 mm, more preferably at least 1 mm and most preferably at least 2 mm depending on the thickness of the adhesive segments 7 i.e. the distance between the two opposite surfaces. Thus, the thicker the adhesive segments are, the larger the spacing between adjacent segments should be.

The adhesive segments 7 may e.g. comprise adhesive selected from a group comprising acrylics, especially 2-ethyl-hexylacrylate or butylacrylate; rubber such as SBR (Styrene-Butadiene Rubber), SBS Polystyrene-Polybutadiene-Polystyrene block copolymer) and SIS (Polystyrene-Polyisoprene-Polystyrene block copolymer); and EVA (Ethylene-vinyl acetate copolymer).

The adhesive segments may comprise an internal flat carrier covered on both sides by adhesive. Such internal carrier could e.g. be made of paper or plastics, possibly foamed.

In FIG. 1 and 2 the liners 11 are completely separated from one another, though not necessarily spaced apart. However as shown in FIG. 3 is possible that adjacent liners 111 are interconnected by narrow fragile bridges 115 of material bridging a gap 117 between adjacent liners 111. FIG. 3 shows three bridges between each pair of liners 111, but preferably only one central bridge 115a or lateral bridges 115b are bridging each gap 117. The bridges 115 may facilitate handling the liners during manufacture or keep the liners from sticking out if the carrier strip is coiled.

In use a user will seize a liner 11 or 111 by the marginal portion and pull the liner away from the carrier strip 1. The adhesive segment 7 will remain attached to the liner and the user may use the liner for pressing the adhesive segment against a substrate onto which the adhesive segment should be transferred.

In case bridges 115 are connecting adjacent liners 111, such bridges should be so fragile that they break easily enough to maintain the impression for the user that the liners are individual.

The adhesive segment adheres more strongly to the liner than to the carrier strip. This may be provided for by providing a coating on the carrier release surface, that adheres less to the adhesive segment than the coating provided on the liner release surface.

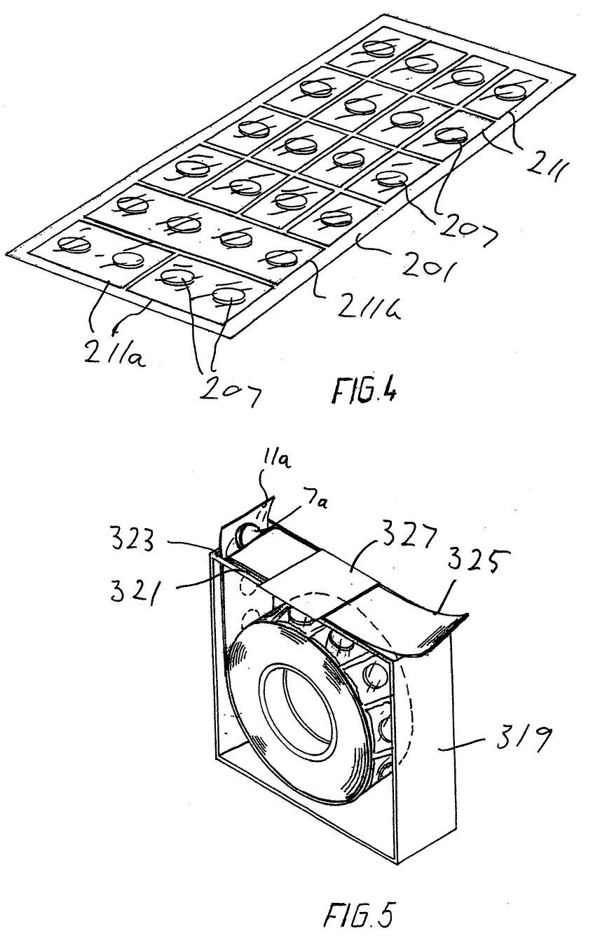

FIG. 4 shows an embodiment, in which the coherent piece of carrier material is a carrier card 201 carrying an array of four times six adhesive segments 207. The adhesive segments 7 are covered by liners 211. As indicated by way of example one liner may cover several adhesive segments. Thus liners 211a covers respectively two adhesive segments, and a liner 211b cover four adhesive segments. This provides for a user removing several adhesive segments at one time if several adhesive segments are to be used substantially simultaneously, e.g. for applying an adhesive segment in either corner of a photograph for attaching it to a page of a photo album. Fragile narrow bridges of material, as shown in FIG. 3, may interconnect adjacent liners 211.

FIG. 5 shows the strip of the embodiment in FIG. 1 rolled into a coil and placed inside a cardboard box 319. The box 319 has a sidewall 321 with a slot 323, through which an uncoiled free end 325 of the carrier strip 1 exits the box. The free end 325 passes below a flap 327, which thus serves as a guide for the free end. The carrier strip 1 makes a sharp bend through the slot 323.

For use a user may pull the free end 325, thereby pulling the carrier strip 1 out of the box. When passing the sharp bend at the slot 323 an adhesive segment 7a together with its liner 11a will peel off the carrier strip 1 ready to be seized by the user. The peeling off occurs the to a combination of the weak adhesion between the adhesive segment 7a and the carrier release surface 3, and an inherent stiffness of the adhesive segment 7 and the liner 11. Due to this effect the adhesive segment may be sure to peel off the carrier strip, when the adhesiveness between the adhesive segment and on one hand the carrier release surface and on the other hand the liner release surface are equal, or even when the adhesiveness between the adhesive segment and the liner release surface is slightly greater than the adhesiveness between the adhesive segment and the carrier release surface.

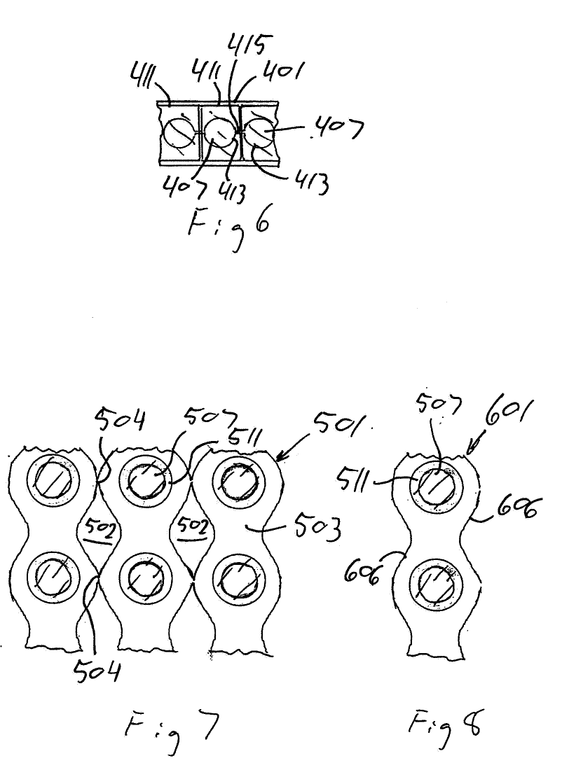

FIG. 6 indicates an embodiment in which a carrier strip 401 carries adhesive segments 407 having interspaced respective circumferential surfaces 413. Narrow fragile bridges 415 of adhesive interconnect adjacent adhesive segments 407. Individual liners 411 cover the individual adhesive segments 407. The adhesive bridges 415 will to a certain degree adhere to the liners 411 and help keeping them from sticking out when the carrier strip is coiled. In this way the adhesive bridges will perform the same function as bridges 115 interconnecting adjacent liners 111 (cf. FIG. 3).

FIG. 7 shows a part of a carrier card 501 comprising a coherent carrier sheet material with cutouts 502 leaving bridges 504 of material. The carrier card is provided with adhesive segments 507 on a carrier release surface 503. Round transparent liners 511 having a margin surrounding the adhesive segment cover the adhesive segments 507. Due to the cutouts 502 the carrier card 501 may easily be divided into strips 601 cf. FIG. 8 by breaking the bridges 504. Such strips 601 having corrugated lateral side edges 606.

In preferred embodiments of the invention the second surface of the carrier material is a non-release surface i.e. a surface, which has not beet treated or coated to be slippery and/or have a low adhesiveness relative to the adhesive segments. Such a non-release surface has several advantages: It adheres very well to adhesive and thus a piece of spend carrier strip or card may be used to wrap and neutralize an adhesive segment dispensed erroneously. Further, when coiling a carrier strip as shown in FIG. 5, the coil will due to internal friction not be inclined to uncoil.

It should be understood that the above embodiments have been described and shown only by way of example and are not intended limit the scope of the invention, which is defined by the claims attached hereto.

We claim,:

1. An adhesive dispensing product comprising,
a coherent piece of carrier sheet material with two opposite surfaces, one of which is a first release surface,
said piece of carrier sheet material having two opposite lateral side edges,
a plurality of individual adhesive segments present on said first release surface,
said adhesive segments each having a circumferential surface, the circumferential surfaces of adjacent adhesive segments being separated by a distance of at least 0.5 mm,
said adhesive segments featuring a first adhesiveness relative to said first release surface allowing the adhesive segments to be dispensed from said first release surface,
a plurality of individual pieces of cover sheet material,
said cover sheet material having two opposite surfaces, one of which is a second release surface,
said adhesive segments featuring a second adhesiveness relative to said second release surface allowing the adhesive segments to be dispensed from said second release surface,
each of said pieces of cover sheet material covering a number of said adhesive segments,
said second release surface of said pieces of cover sheet material comprising a margin extending beyond at least a part of the circumferential surface of the respective adhesive segments.

2. An adhesive dispensing product according to claim 1, wherein said distance is at least 1 mm.

3. An adhesive dispensing product according to claim 1, wherein said distance is at least 2 mm.

4. An adhesive dispensing product according to claim 1, wherein two pieces of cover sheet material of any pair of adjacent pieces of cover sheet material are connected by a number of narrow fragile bridges of material.

5. An adhesive dispensing product according to claim 4, wherein said number is less than four.

6. An adhesive dispensing product according to claim 1, wherein adjacent individual adhesive segments are connected by a narrow fragile bridge of adhesive.

7. An adhesive dispensing product according to claim 1, wherein the adhesive segments comprise adhesive selected from a group comprising acrylics; rubber; and EVA (Ethylene-vinyl acetate copolymer).

8. An adhesive dispensing product according to claim 7, wherein the adhesive segments comprise adhesive selected from a group comprising 2-ethyl-hexylacrylate; butylacrylate; SBR (Styrene-Butadiene Rubber); SBS Polystyrene-Polybutadiene-Polystyrene block copolymer); SIS (Polystyrene-Polyisoprene-Polystyrene block copolymer); and EVA (Ethylene-vinyl acetate copolymer).

9. An adhesive dispensing product according to claim 1, wherein the adhesive segments are of a clean adhesive.

10. An adhesive dispensing product according to claim 1, wherein the individual adhesive segments comprises an internal carrier covered by adhesive.

11. An adhesive dispensing product according to claim 1, wherein the coherent piece of carrier material is a strip carrying a row of adhesive segments.

12. An adhesive dispensing product according to claim 1, wherein the coherent piece of carrier material is a card carrying an array of adhesive segments.

13. An adhesive dispensing product according to claim 1, wherein said second adhesiveness is greater than said first adhesiveness.

14. An adhesive dispensing product according to claim 1, wherein said cover sheet material is translucent.

15. An adhesive dispensing product according to claim 1, wherein said cover material is transparent.

16. An adhesive dispensing product according to claim 1, wherein the margins of the second release surface of the pieces of cover sheet material are surrounding the adhesive segments.

17. An adhesive dispensing product according to claim 1, wherein a second surface of said carrier sheet material is a non-release surface.

18. An adhesive dispensing product according to claim 1, wherein a second surface of said cover sheet material is a non-release surface.

19. An adhesive dispensing product comprising,
a coherent card of carrier sheet material with two opposite surfaces, one of which is a first release surface,
said piece of carrier sheet material having two opposite lateral side edges,
an arrayed plurality of individual adhesive segments present on said first release surface,
said adhesive segments each having a circumferential surface, the circumferential surfaces of adjacent adhesive segments being separated by a distance,
said adhesive segments featuring a first adhesiveness relative to said first release surface allowing the adhesive segments to be dispensed from said first release surface,
a plurality of individual pieces of cover sheet material,
said cover sheet material having two opposite surfaces, one of which is a second release surface,
said adhesive segments featuring a second adhesiveness relative to said second release surface allowing the adhesive segments to be dispensed from said second release surface,
said second adhesiveness being not less than said first adhesiveness,
each of said pieces of cover sheet material covering a number of said adhesive segments,
said second release surface of said pieces of cover sheet material comprising a margin extending beyond at least a part of the circumferential surface of the respective adhesive segments.

20. An adhesive dispensing product comprising,
a box containing,
a coiled coherent strip of carrier sheet material with two opposite surfaces, one of which is a first release surface,
said piece of carrier sheet material having two opposite lateral side edges,
a row of a plurality of individual adhesive segments present on said first release surface,
said adhesive segments each having a circumferential surface, the circumferential surfaces of adjacent adhesive segments being separated by a distance,
said adhesive segments featuring a first adhesiveness relative to said first release surface allowing the adhesive segments to be dispensed from said first release surface,
a plurality of individual pieces of cover sheet material,
said cover sheet material having two opposite surfaces, one of which is a second release surface,
said adhesive segments featuring a second adhesiveness relative to said second release surface allowing the adhesive segments to be dispensed from said second release surface,
each of said pieces of cover sheet material covering a number of said adhesive segments,
said second release surface of said pieces of cover sheet material comprising a margin extending beyond at least a part of the circumferential surface of the respective adhesive segments,
said box comprising a slot for exiting an uncoiled end of said strip, an outer surface adjacent said slot and a guide for guiding said uncoiled end along said outer surface, the uncoiled end of the strip there by following a path, said path making a sharp bend through said slot.
